(19) United States
(12) Patent Application Publication
(10) Pub. No.: US 2010/0054744 A1
(43) Pub. Date: Mar. 4, 2010

(54) SYSTEMS AND METHODS FOR DETECTING ORIENTATION OF AN OPTICAL EMITTER WITH RESPECT TO DETECTOR USING OPPOSITELY POLARIZED BEAMS FOR REFERENCE

(76) Inventor: Brian D. Maxson, Riverside, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/547,064

(22) Filed: Aug. 25, 2009

Related U.S. Application Data
(60) Provisional application No. 61/093,337, filed on Aug. 31, 2008.

(51) Int. Cl. H04B 10/00

(52) U.S. Cl. 398/106

(57) ABSTRACT

The embodiments provided herein are directed to pitch and yaw sensitive remote control of televisions and the like using polarized light. In a preferred embodiment, the remote control unit and the infrared (IR) signal detection system of the television are sensitive to the pitch and yaw of the remote control unit relative to the television.

### CROSS-REFERENCE TO RELATED APPLICATION

This application claims priority to provisional application Ser. No. 61/093,337 filed Aug. 31, 2008, which application is fully incorporated herein by reference.

### FIELD

The embodiments described herein relate generally to remote control of televisions and, more particularly, to systems and methods that facilitate the detection of the orientation of an optical emitter with respect to a detector using oppositely polarized beams for reference.

### BACKGROUND INFORMATION

As the capabilities of televisions and other components have increased, so have the capabilities and complexity of their remote control units. In order to accommodate or control the increasing number of features or capabilities of the television and related input audio-video devices, more and more feature or user interface dedicated buttons or keys have been added to the remote control unit.

On such remote controls, pushbuttons are the least costly type of control to implement. As a result, pushbuttons are often used to operate functions that are not inherently on-off, for example channel-up/channel-down or volume up/down buttons on a TV remote. Such functions, in an earlier technology, would have been implemented with a rotatable dial or knob. These were more intuitive and easier to operate, but were more expensive and less reliable. It is desirable to provide a similar sort of “analog” control mechanism on a digital remote, while avoiding those disadvantages.

### SUMMARY

The embodiments provided herein are directed to systems and methods that facilitate the detection of the orientation of an optical emitter with respect to a detector using oppositely polarized beams for reference. In a preferred embodiment, the remote control unit and the infrared (IR) signal detection system of the television are sensitive to the pitch and yaw of the remote control unit relative to the television. The remote control preferably comprises one or more IR emitting LEDs, and a rotator and mask assembly. The rotator preferably comprises a slit and a slit plus a quarter-wave retarder plate that rotates the light 90 degrees. The mask comprises a pair of complimentary masks through which the light at the two polarizations passes.

The ability to sense the pitch and yaw orientation of a remote control unit with respect to a television, advantageously allows, among other things, for the remote control unit to be used as a rudimentary pointing/selection device to navigate, e.g., a graphical user interface displayable on the television screen and make selections and/or adjustment to operating parameters, or for the user's gestures to be sensed, and the like.

Other systems, methods, features and advantages of the example embodiments will be or will become apparent to one with skill in the art upon examination of the following figures and detailed description.

### BRIEF DESCRIPTION OF THE FIGURES

The details of the example embodiments, including fabrication, structure and operation, may be gleaned in part by study of the accompanying figures in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 is a schematic of a television and control system.

FIG. 2 is a schematic showing an IR LED in remote control unit split into 2 polarized beams and masked.

FIG. 3A is a schematic showing side-to-side rotation (yaw) of the remote control unit which puts a different area of the mask between LED and detector and the light emitted through the mask and seen by the detector.

FIG. 3B is a schematic showing pitch (Θ) and yaw (ψ) angles of rotation for a remote control unit relative to the screen of a television.

FIG. 4 is a schematic showing three LEDs with pairs of masks for each and a pair of detectors behind polarizing filters.

FIG. 5A is a schematic showing the light emitted from three LEDs lit in sequence and passing through the pairs of masks for each and seen by the pair of detectors behind polarizing filters.

FIG. 5B is a schematic showing the light emitted from six LEDs lit in sequence and passing through the pairs of masks for each and seen by the pair of detectors behind polarizing filters to provide both pitch and yaw angular orientation of the remote control unit relative to the television.

FIG. 6 is a schematic showing IR pulses.

FIG. 7A is a perspective view of a remote control unit.

FIG. 7B is a schematic of an IR detector system circuit.

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

The systems and methods described herein are directed to the sensing of the pitch and yaw orientation of a device, such as a remote control unit, incorporating one or more IR emitters. In a preferred embodiment, the light of an IR LED is rotated in polarization and portions of the beam pass through two masks. Depending on orientation of the emitter device, a different part of the mask sits between the IR LED and a distant detector. Disregarding polarization, the amount of light sent from emitter to the detector remains constant. But when considering polarization, the detector can discern the degree to which each polarized portion of the beam is attenuated by its mask and hence, the orientation of the remote control.

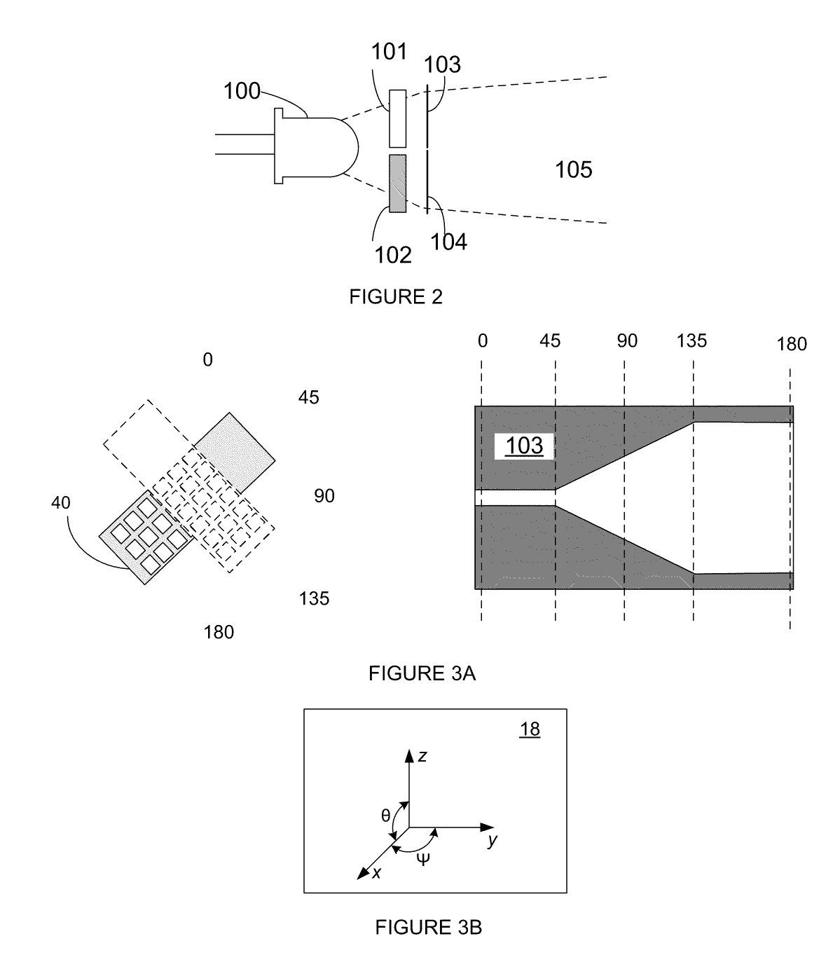

The LED/rotator/mask assembly, which is discussed in greater detail below with regard to FIG. 2, is duplicated with different masks in the emitter device, giving a different view of the orientation that can be combined with the first. The LEDs of each assembly are lit in a sequence known by the detector, such that the detector can combine its measurements of the light from each of the LEDs into a position measurement of desired accuracy. In effect, the number of LEDs in the emitter and number of bits in an A/D converter in the detector can be traded off, at any given desired accuracy, to give the best economic benefit.

This scheme can be duplicated for a third axis of orientation of the remote, see, e.g., U.S. patent application No. 61/093,336, which is incorporated herein by reference and which describes a means for measuring rotation of the emitter about an axis connecting emitter and detector, and they can be combined therewith. Thus, orientation on all three axes of rotation of the emitter can be sensed, if desired.

Although example embodiments are described herein with regard to a television and remote control unit, one of skill in the art would readily recognize that the embodiments are equally applicable to other audio-video devices and to other applications that use an IR emitter.

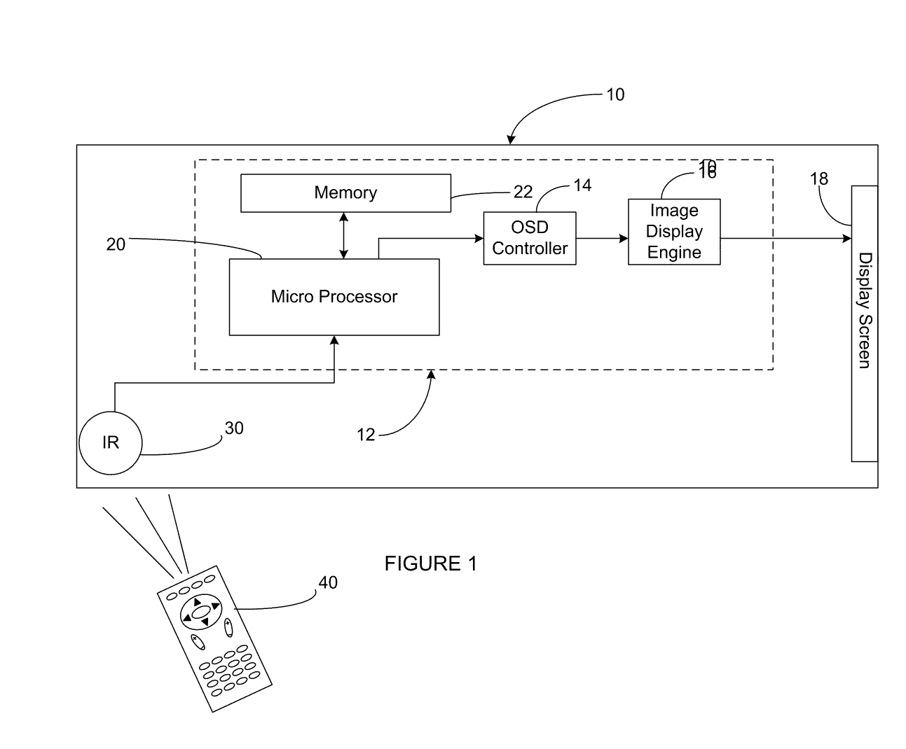

Turning in detail to the figures, FIG. 1 depicts a schematic of an embodiment of a television 10. The television 10 preferably comprises a video display screen 18 and an IR signal receiver or detection system 30 coupled to a control system 12 and adapted to receive, detect and process IR signals received from a remote control unit 40. The control system 12 preferably includes a micro processor 20 and non-volatile memory 22 upon which system software is stored, an on screen display (OSD) controller 14 coupled to the micro processor 20, and an image display engine 16 coupled to the OSD controller 14 and the display screen 18. The system software preferably comprises a set of instructions that are executable on the micro processor 20 to enable the setup, operation and control of the television 10. The system software provides a menu-based control system that is navigatable by the user through a graphical user interface displayed or presented to the user on the television display 18. While on the television layer of the television remote control unit, the user can navigate the graphical user interface to setup, operate and control the television 10 and external A-V input devices, such as, e.g., a DVD, a VCR, a cable box, and the like, coupled to the television 10. A detailed discussion of a graphical user interface-based menu control system and its operation is provided in U.S. Published Patent Application No. US 2002-0171624 A1, which is incorporated herein by reference. The '624 application describes the menu-based control system and its operation with regard to the centralized control of audio-video components coupled to a television and controlled using a menu-based control system with a graphical user interface.

In a preferred embodiment, a remote control unit incorporates one or more components of the type illustrated in FIG. 2. As depicted, light emitted from an IR LED 100, which is already polarized, passes through two components—a slit 101 and a slit plus a quarter-wave retarder plate 102 that rotates its polarization by 90 degrees. The light at these two polarizations then passes through two masks 103 and 104 that are complements of one another. The combined portions of the beam 105 travel to a detector which can sense polarization, compare the signal level at each polarization, and determine the portion of the mask between emitter and detector.

FIG. 3A illustrates one of the two masks 103 or 104 as it applies to detecting right/left (yaw) orientation of the remote control unit 40. As depicted in FIG. 3B, yaw (ψ) is the remote control's right/left angular orientation in the x-y plane or its rotation about the z-axis while pitch (θ) is the remote control's up/down angular orientation in the x-z plane or its rotation about the y-axis. As shown in FIG. 3A, the remote control unit 40 could, for example, yaw at:

zero degrees (pointing ninety degrees away from the television);

45 degrees (pointing somewhere closer to the left-hand side of the television);

90 degrees (pointing directly at the detector in the television);

135 degrees (pointing somewhere closer to the right-hand side of the television); and

180 degrees (pointing ninety degrees away from the television again).

As depicted, side-to-side rotation of the remote control unit 40 puts a different area of the mask 103 or 104 between the LED 100 and the detector. The right hand side of FIG. 3 illustrates one mask 103 of a pair of masks 103 or 104, showing the position of the slit 101 in front of the mask 103 at each of the listed orientations. This example indicates that only the central range of yaw, from 45-135 degrees, is of interest. Therefore, in the central portion of the mask 103 or 104, progressively more light is admitted through the mask in this range.

A second mask 104 preferably looks like a complement of the first mask 103 wherein the most light is admitted at the 45 degree orientation and the least at the 135 degree side. Therefore a pair of polarization-sensitive detectors with sufficiently sensitive A/D convertors could tell the angular rotation of the emitter device 40 by comparing the light detected at each of the angular locations. At any orientation, disregarding polarization direction, a detector sees the same amount of light from the IR LED. This becomes a reference value that allows the system to largely disregard noise (light from other sources.) Consequently a remote control equipped as described could be used with a conventional (polarization-insensitive) IR detector.

But if in the television, a pair of detectors covered by polarizing filters is used, two different values can be compared with the reference and with each other to determine the relative amount of light that came from the LED at any orientation within the illustrated range of 45-135.

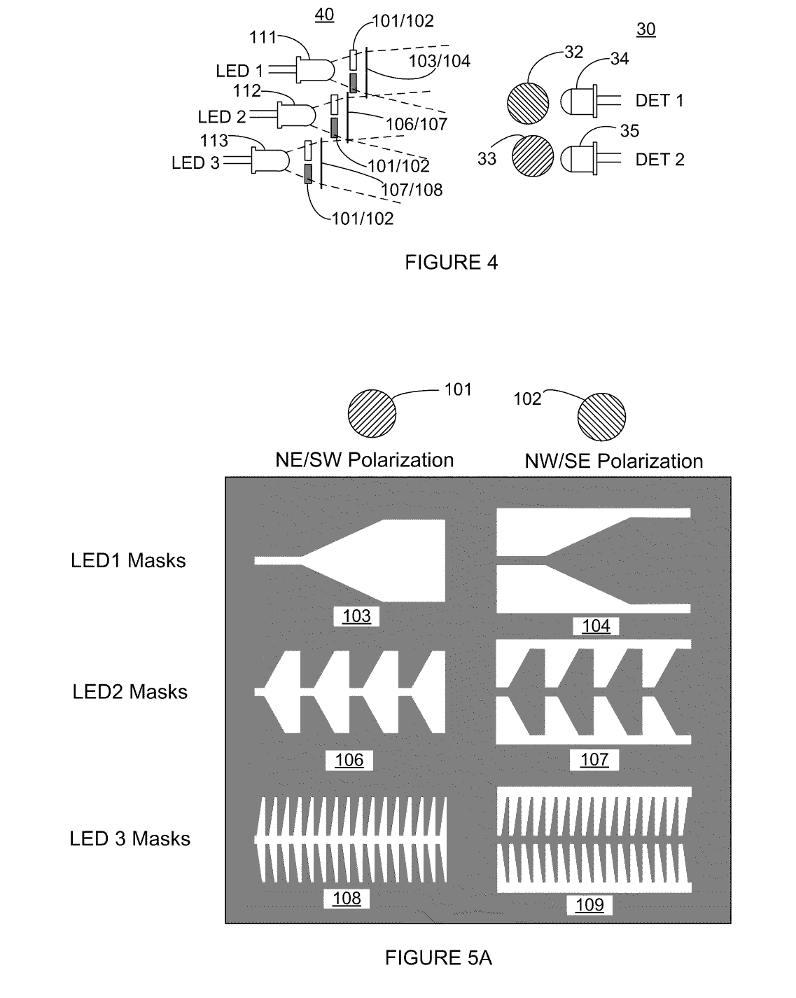

The accuracy of the measurement of orientation depends upon the ability of the system to reject noise, and the bit resolution of the analog-to-digital (A/D) converter in the detector. It may be desirable overall, either for reasons of noise rejection or to simplify and reduce cost in the A/D converter, to use a lower-resolution A/D converter in the television 10 and use one or more additional LEDs and pairs of masks in the emitter 40. FIG. 4A shows an example configuration that uses a 2-bit A/D converter at the detector 30 with three (3) LEDs 111, 112, 113, preferably vertically stacked, one or more rotators having a slit 101 and a slit plus a quarter-wave retarder plate 102, and three (3) pairs of masks 103/104, 106/107 and 108/109 at the emitter 40. In combination, an 8-bit yaw position, the product of three two-bit values, can be derived. (In practice, four bits of yaw position may be sufficient, and therefore if using a two-bit A/D converter, only two LED/mask assemblies are required.)

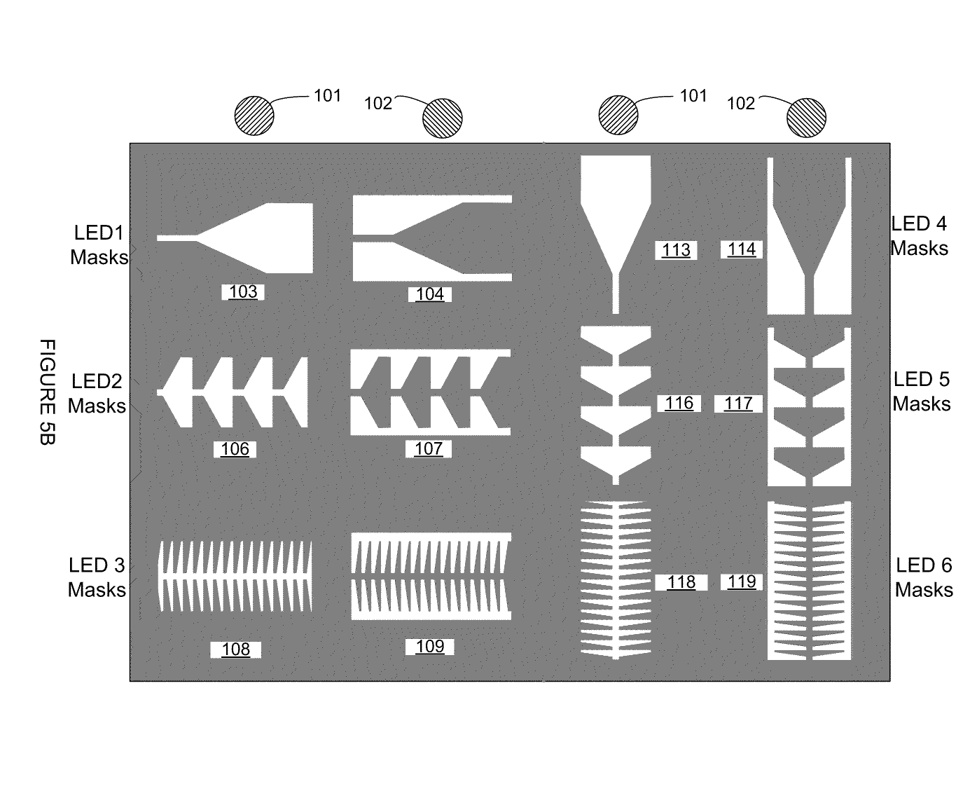

In FIG. 5A, LED1 112 is lit first. Its light at the two polarizations passes through the pair of complimentary masks 103 and 104 illustrated. At the television 10, a pair of detectors 34 and 35 covered by filters 32 and 33 (see FIG. 7) provide signals to 2-bit A/D converters that are part of pre-amp assemblies 36 and 37. This is sufficient to tell at which one-fourth of the mask did the slit fall. To extend or fine tune the accuracy, LED2 112, which has a pair of complimentary masks 105 and 106 with gradations that change at four times the rate of LED1's masks 103 and 104, is lit second. Consequently LED2 masks 105/106 traverses the full range of gradation four times for each time that LED1's masks 103/104 traverses the range once. When LED2 112 is lit, the 2-bit A/D again resolves the yaw position within an additional 2 bits of accuracy. Consequently the yaw orientation of the remote control can be discerned to within the nearest 1/16 of its measured range. To extend the prior example in FIG. 3, if the useful range is 45-135 or 90 degrees, then the yaw position may be determined to the nearest 90/16 or about 6 degrees.

To further extend or fine tune the accuracy, a third LED 113, LED3, can be added with a pair of complimentary masks 107 and 108 having gradations that change at four times the rate of LED2's masks 105 and 106 and, thus, traverse the same range four times as frequently as that of LED2 masks 105 and 106, resulting in a full 8 bits of yaw position of the remote control being derived. Consequently the yaw orientation of the remote control can be discerned to within the nearest 1/64 of its measured range. If the useful range is 45-135 or 90 degrees, then the yaw position may be determined to the nearest 90/16 or about 1 to 2 degrees.

In the foregoing description, the embodiments were given addressing rotation of the remote control in the yaw direction. As should be clear, the same methodology is applicable to the yaw orientation, pitch orientation, or both. In the case of the pitch orientation, the organization of the masks is simply rotated 90 degrees from what is illustrated in FIGS. 3 and 5A. The pitch position or orientation of the remote can be determined with a second set of three (3) LEDs (LED 4, LED 5 and LED6), preferably vertically stacked, one or more rotators having a slit 101 and a slit plus a quarter-wave retarder plate 102, and three (3) pairs of masks 113/114, 116/117 and 118/119 at the emitter 40. As shown in FIG. 5B, mask pairs 113/114, 116/117 and 118/119 are the same complimentary mask pairs as the first set of mask pairs 103/104, 106/107 are 108/109, but are preferably rotated 90° relative to the first set of mask pairs.

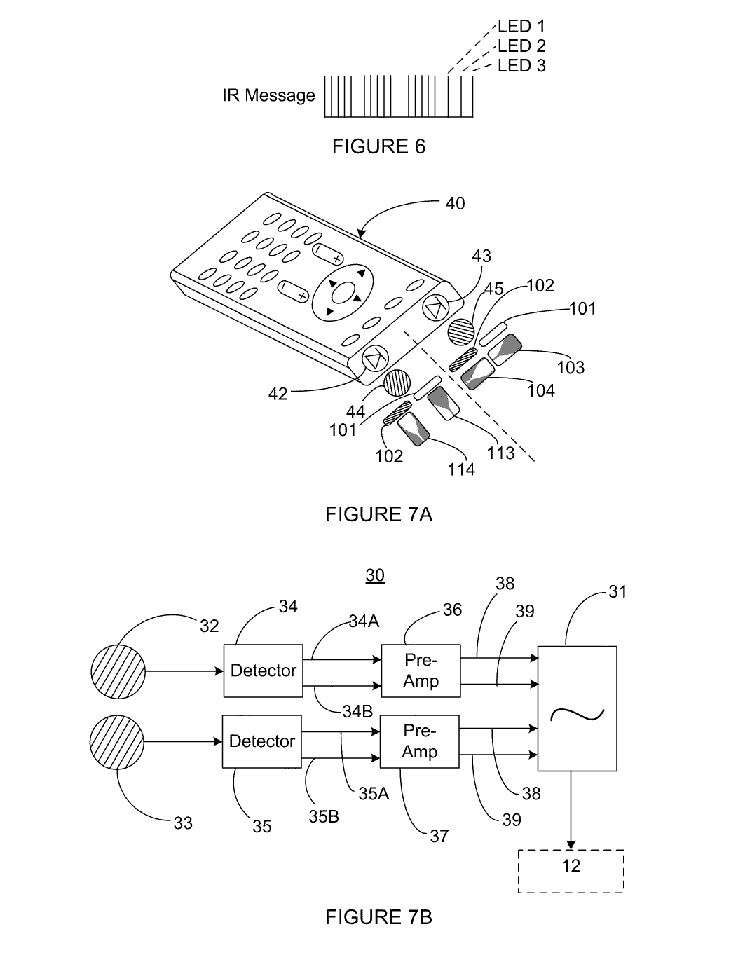

In practice, the signal from the multiple LEDs is multiplexed in time. This multiplexing might be transmitted, for example in the IR pulses comprising the carrier frequency of the remote. Or the remote's conventional IR message might be extended to include (in an example with three LEDs) three more pulses at the end or (in an example with six LEDs) six more pulses at the end, each of which is of sufficient duration for the A/D converter to capture. (see FIG. 6). Movement of the remote control unit, side-to-side and/or up-and-down, in coordination with the depression of keys or buttons on the remote control unit enables enhanced and quicker navigation, similar to a computer mouse, through a list of options presented in a user interface displayed on the television screen such as, for example, to turn up or down the volume with a single motion, change picture parameters such as color, brightness, contrast, etc, with a single motion, make menu and/or program guide selections, and the like. Specifically, to make a program guide selection, for example, a user points the remote control unit at the television, holds the select or some other dedicated function key down, and rotates the remote side-to-side and/or up-and-down. The user then releases the select key when the desired selection has been identified.

Turning to FIG. 7A, a remote control unit 40 is shown to include first and second or right and left LED assemblies 42 and 43, which can comprise one or more LEDs (see FIGS. 4, 5A and 5B), positioned at the front end of the remote control unit 40. The natural polarization of the LED assemblies 42 and 43 is 90 degrees apart, illustrated here as if it were two polarizing filters 44 and 45. The light from an IR LEDs 42 and 43, which is already polarized, passes through two components—a slit 101 and a slit plus a quarter-wave retarder plate 102 that rotates its polarization by 90 degrees. The light at these two polarizations then passes through a pair of complementary masks 103/104 and 113/114. The combined portions of the beam 105 travel to a detector system which can sense polarization, compare the signal level at each polarization, and determine the portion of the mask between emitter and detector and, thus, the pitch and yaw orientation of the remote control.

FIG. 7B shows a preferred IR signal detection or receiver system 30 of the television 10 shown in FIG. 1. The system 30 includes a pair of polarizing filters 32 and 33 placed in front of a pair of separate IR detectors 34 and 35 which each coupled to a preamp assembly 36 and 37, which produce digital values 38 and 39, which are coupled to a processor 31. The IR detectors 34 and 35 measure the amount of light received from the two LEDs 42 and 43 of the remote control unit 40 and then produce two analog voltages 34A and B and 35A and B in response. The preamp assemblies 36 and 37 filter out some interference, scale the two voltages against the reference sensed when no LEDs are lit, then converting the resulting signals to digital values in a low-resolution A/D convertor. The two digital values 38 and 39 are used by software executing on the processor 31, which is cognizant of the multiplexing of LEDs and thus can identify by position in the sequence, of light coming from (in the terms of FIG. 5) LED1, LED2 and LED3 or (in the terms of FIG. 5) LED1, LED2, LED3, LED4, LED5 and LED6. The software compares the polarized components at the time that each LED is lit, combining the result of multiple low-resolution values into a single higher-resolution one, and from that deriving an instantaneous measure of the rotation or angular orientation (pitch and yaw) of the remote control, that can be used by the control system to change or adjust television features or parameters, or used by the user-interface module of the system software to navigate and operate the user-interface, e.g., operate an adjustment bar for volume or picture parameters, navigate a menu, table or program guide, sense users gestures for gaming or other applications, and the like.

Since rotations will tend to be continuous, processor 38 might incorporate a Kalman filter or other such processing to the digitized quadrature values. This would permit a relatively good estimate of the angular value while permitting lower-resolution A/D sampling of the light signal from the detectors 34 and 35.

In the case of a remote control whose position is sensed in both the pitch and yaw direction, the number of LEDs is increased to one, two, or more in each of the pitch and raw directions. Similarly the IR message sent by the remote must be multiplexed into proportionally more time periods during which the greater number of LEDs are illuminated one at a time. The detectors 34 and 35, and pre-amps 36 and 37 will work as illustrated when sensing both pitch and yaw. But the software running on processor 31 must take into account the extra signals multiplexed into the IR message and recognize the portions that apply to the pitch direction as well as the yaw direction.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions shown in the process flow diagrams described herein is merely illustrative, unless otherwise stated, and the invention can be performed using different or additional process actions, or a different combination or ordering of process actions. As another example, each feature of one embodiment can be mixed and matched with other features shown in other embodiments. Features and processes known to those of ordinary skill may similarly be incorporated as desired. Additionally and obviously, features may be added or subtracted as desired. Accordingly, the invention is not to be restricted except in light of the attached claims and their equivalents.

What is claimed is:

1. A pitch and yaw sensitive remote control system comprising
a remote control unit comprising
first and second LEDs positioned at the front end of the remote control unit, the LEDs having differing polarizations,
first and second rotators positioned in front of the first and second LEDs and a portion of each beam emitted from each LED a predetermined polarization, and
first and second pair of masks positioned in front of the first and second rotators, the first pair of masks configured to mask the emission of light in the yaw orientation of the remote control unit and the second pair of masks and configured to mask the emission of light in the pitch orientation of the remote control unit, and
an IR detection system adapted to sense the polarization of each of a plurality of beams emitted from the remote control unit, compare the signal level at each polarization, and determine the portion of the mask between the emitter and a detector of the IR detection system.

2. The system of claim 1 wherein each rotator comprises a slit and a slit plus a quarter-wave retarder plate that rotates the light 90 degrees.

3. The system of claim 1 wherein each of the first and second LEDs comprises two or more LEDs.

4. The system of claim 1 wherein IR detection system includes a pair of IR detectors and a pair of polarizing filters positioned in front of the pair of IR detectors.

5. The system of claim 4 wherein the IR detection system further comprises first and second preamp assemblies configured to produce digital outputs and coupled to each of the IR detectors, and a processor coupled to the first and second preamp assemblies.

6. A television system comprising pitch and yaw sensitive remote control system comprising
a display screen,
an on screen display controller,
a remote control unit comprising
first and second LEDs positioned at the front end of the remote control unit, the LEDs having differing polarizations,
first and second rotators positioned in front of the first and second LEDs and a portion of each beam emitted from each LED a predetermined polarization, and
first and second pair of masks positioned in front of the first and second rotators, the first pair of masks configured to mask the emission of light in the yaw orientation of the remote control unit and the second pair of masks and configured to mask the emission of light in the pitch orientation of the remote control unit, and
a control system coupled to the on screen display controller, the control system including an IR detector system adapted to sense the polarization of each of a plurality of beam emitted from the remote control unit, compare the signal level at each polarization, and determine the portion of the mask between the emitter and a detector of the IR detection system,
wherein the control system includes a graphical user interface system displayable on the screen.

7. The system of claim 6 wherein the IR detection system comprises
first and second IR detectors,
first and second polarizing filters positioned in front of the first and second IR detectors, and
a logic unit capable of sensing the patterns of illumination of the first and second LEDs on the remote control unit and sense the polarization of each of a plurality of beam emitted from the remote control unit, compare the signal level at each polarization, and determine the portion of the mask between the emitter and a detector of the IR detection system

8. The system of claim 6 wherein each rotator comprises a slit and a slit plus a quarter-wave retarder plate that rotates the light 90 degrees.

9. The system of claim 4 wherein the control system is adapted to use the derived position of the remote control unit to derive and display a user's navigation, selection or adjustments within the graphical user interface.

10. A process of controlling a television comprising the steps of
sensing the polarization of each of a plurality of beams emitted from a remote control unit,
comparing the signal level at each polarization, and
determining the portion of first and second masks between the emitter and a detector of the IR detection system, wherein the first mask is oriented in a yaw direction and the second mask is oriented in a pitch direction.

11. The process of claim 10 further comprising the steps of
transmitting IR signals comprised of patterns of illumination from which the contribution of each of the plurality of LEDs can be extracted.

12. The process of claim 11 further comprising the steps of
filtering the IR signals sensed by an IR detector with a polarized filter.

13. The process of claim 12 further comprising the steps of
navigating a user interface as a function of the portion of the mask determined to be between the emitter and the detector.

14. The process of claim 12 further comprising the steps of
navigating a user interface as a function of the pitch or yaw orientation of the remote control unit.
